(19) United States
(12) Patent Application Publication
(10) Pub. No.: US 2026/0191352 A1
(43) Pub. Date: Jul. 9, 2026

(54) LIFTING HANDLE MECHANISM

(71) Applicant: Foshan WinLin Smart Technology Co., Ltd, Foshan (CN)

(72) Inventors: Jingdan XU, Foshan (CN); Huiling ZENG, Foshan (CN)

(73) Assignee: Foshan WinLin Smart Technology Co., Ltd, Foshan (CN)

(21) Appl. No.: 19/019,361

(22) Filed: Jan. 13, 2025

(30) Foreign Application Priority Data
Jan. 6, 2025 (CN) 202520016945.6

(51) Int. Cl. A47J 31/44

(52) U.S. Cl. CPC A47J 31/4407

(57) ABSTRACT

The present disclosure relates to the technical field of frozen drink making machines, and provides a lifting handle mechanism capable of being opened or locked by means of lifting or pressing. When first ends of locking assemblies (30a, 30b) move to first ends of limiting assemblies (130a), clamping assemblies (20b) are separated from the locking assemblies (30a, 30b) so as to control a mixing container (20) to be separated from a main body (10). When second ends of the locking assemblies (30a, 30b) move to second ends of the limiting assemblies (130a), the limiting assemblies (130a) are embedded into the clamping assemblies so as to lock the mixing container (20) on the main body (10).

### RELATED APPLICATIONS

The present patent document claims the benefit of priority to Patent Application No. 202520016945.6, filed Jan. 6, 2025, and entitled “LIFTING HANDLE MECHANISM,” the entire contents of each of which are incorporated herein by reference.

### BACKGROUND

### 1. Technical Field

The present disclosure relates to the technical field of frozen drink making machines, in particular to a lifting handle mechanism.

### 2. Background Information

A drink making machine can be called a semi-frozen drink making machine or a crushed ice drink making machine, and generally includes a transparent tank or mixing container for receiving and processing a drink product. The processing includes cooling, which often changes the drink product from a pure liquid (or a combination of the liquid and part of ice) to a frozen or semi-frozen product, for example, slush ice, a slush drink, a smoothie, an ice cream or other frozen or semi-frozen products, and then the product is distributed. At least a mixing blade or twist drill rotated by a motor through a driving shaft rod and a driving assembly is provided in the mixing container. After the drink making machine is used for a certain period of time, the transparent tank or the mixing container needs to be separated from a main body, thereby cleaning the mixing container, the mixing blade or the twist drill.

However, for the mixing container of the traditional frozen drink making machine on the market, a lifting handle mechanism is locked or opened in a level rotating manner, and a configured mechanism for the level rotating manner and the opening or locking action process are relatively complex, resulting in poor user experience.

### BRIEF SUMMARY

The technical problem to be solved by the present disclosure is to provide a lifting handle mechanism capable of being opened or locked by means of lifting or pressing, so as to overcome the defects that for the mixing container in the prior art, the lifting handle mechanism is locked or opened in the level rotating manner and the configured mechanism for the level rotating manner and the opening or locking action process are relatively complex.

The technical solution adopted by the present disclosure to solve the technical problem is to construct a lifting handle mechanism applied to a frozen drink making machine, where
at least one limiting assembly is disposed on a main body, and at least one clamping assembly is disposed on a mixing container;
the at least one clamping assembly is disposed on an adjacent side of the limiting assembly;
the lifting handle mechanism is provided with a locking assembly matched with the limiting assembly;
when a first end of the locking assembly moves to a first end of the limiting assembly, the clamping assembly is separated from the locking assembly so as to control the mixing container to be separated from the main body; and
when a second end of the locking assembly moves to a second end of the limiting assembly, the clamping assembly is embedded into the locking assembly so as to lock the mixing container on the main body.

In some embodiments, a symmetric open groove is formed in an inner side of the locking assembly;
a notch is formed in one end of the open groove along an outer edge of the locking assembly; and
the notch is configured for placement or separation of the clamping assembly.

In some embodiments, when the first end of the locking assembly moves to the first end of the limiting assembly, the clamping assembly is separated from the locking assembly by means of the open groove; and
when the second end of the locking assembly moves to the second end of the limiting assembly, the clamping assembly is embedded into the locking assembly by means of the open groove.

In some embodiments, a through groove is formed in the locking assembly, and a placement groove is formed in an inner side of the through groove; and
an end surface of the limiting assembly is attached to an end surface of the placement groove, and an extending portion of the limiting assembly is disposed inside the through groove.

In some embodiments, a placement cavity is formed on one side of the through groove, and a through circular hole is formed in the placement cavity.

In some embodiments, an elastic assembly is configured inside the placement cavity, and one end of the elastic assembly passes through the through circular hole.

In some embodiments, the elastic assembly at least includes a support member, a spring assembly and a movable member;
a concave ring is formed in an end surface of the support member, and a through hole is formed in the concave ring;
one end of the spring assembly is clamped inside the concave ring;
the movable member is sleeved with the spring assembly, and the other end of the spring assembly abuts against one end of the movable member; and
one end of the movable member is configured inside the through hole.

In some embodiments, a first concave hole and a second concave hole are formed on an opposite side of the clamping assembly; and
the first concave hole and the second concave hole are radially formed.

In some embodiments, when the first end of the locking assembly moves to the first end of the limiting assembly, the other end of the movable member is embedded into the first concave hole; and
when the second end of the locking assembly moves to the second end of the limiting assembly, the other end of the movable member is embedded into the second concave hole.

In some embodiments, a connecting assembly is disposed between the locking assemblies.

The lifting handle mechanism in the present disclosure is applied to the frozen drink making machine. When the first end of the locking assembly moves to the first end of the limiting assembly, the clamping assembly is separated from the locking assembly so as to control the mixing container to be separated from the main body. When the second end of the locking assembly moves to the second end of the limiting assembly, the limiting assembly is embedded into the clamping assembly so as to lock the mixing container on the main body. Compared with the prior art, the lifting handle mechanism can be lifted or pressed to be opened or locked; when the lifting handle mechanism is lifted upwards, the first end of the locking assembly moves to the first end of the limiting assembly, and the clamping assembly can be pushed by means of the sliding rail/through groove to open the mixing container; and when the lifting handle mechanism is pressed downwards, the second end of the locking assembly moves to the second end of the limiting assembly, and the clamping assembly can be clamped into the locking assembly to lock the mixing container.

### BRIEF DESCRIPTION OF THE DRAWINGS

The present disclosure will be further described below in conjunction with the accompanying drawings and embodiments. In the drawings:

FIG. 1 is a stereogram of an embodiment of a frozen drink making machine provided in the present disclosure;

FIG. 2 is a stereogram of another embodiment of a frozen drink making machine provided in the present disclosure;

FIG. 3 is an exploded view of an embodiment of a frozen drink making machine provided in the present disclosure;

FIG. 4 is a matching schematic diagram of an embodiment of a main body and a mixing container provided in the present disclosure;

FIG. 5 is a stereogram of an embodiment of a rear cover body provided in the present disclosure;

FIG. 6 is a stereogram of an embodiment of a lifting handle mechanism provided in the present disclosure;

FIG. 7 is an enlarged view at part A in FIG. 1;

FIG. 8 is an enlarged view at part B in FIG. 2;

FIG. 9 is a stereogram of an embodiment of an elastic assembly provided in the present disclosure; and

FIG. 10 is a stereogram of an embodiment of a support member provided in the present disclosure.

### DETAILED DESCRIPTION OF THE DRAWINGS AND THE PRESENTLY PREFERRED EMBODIMENTS

To understand the technical features, purposes and effects of the present disclosure more clearly, the particular embodiments of the present disclosure are now described in detail with reference to the accompanying drawings.

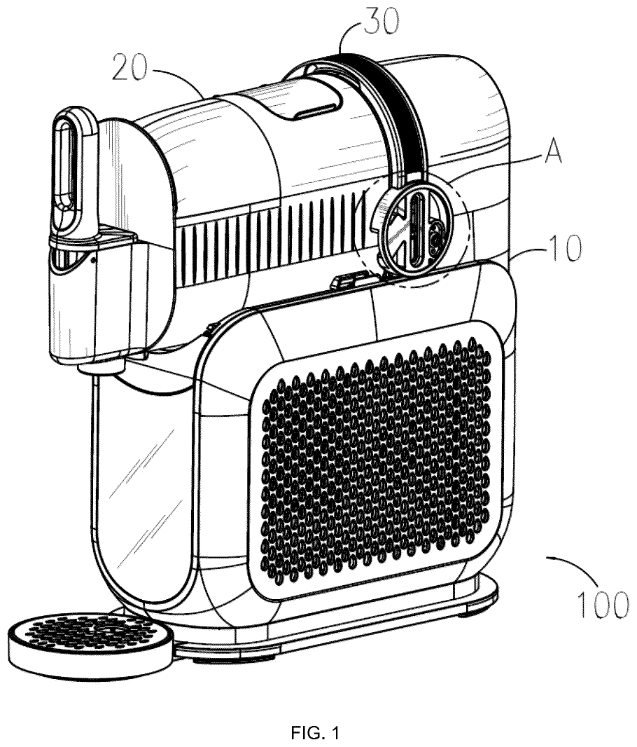

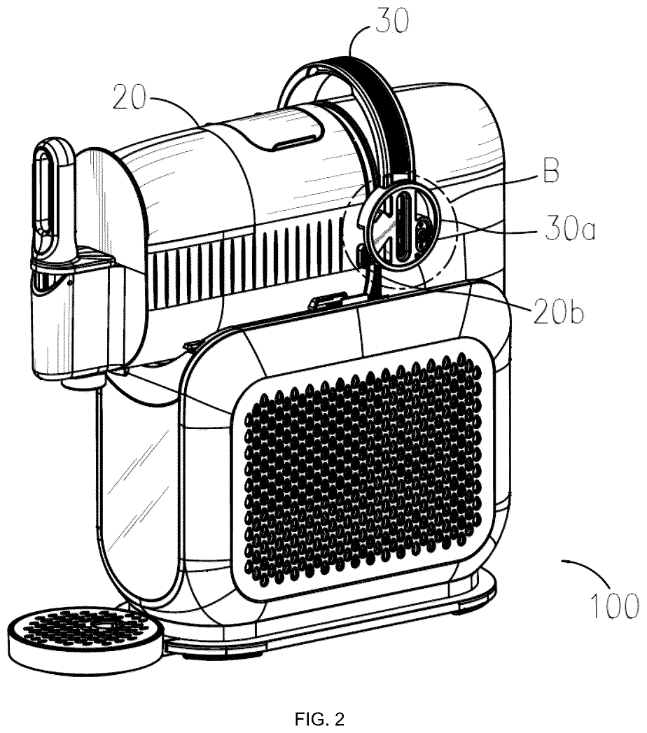

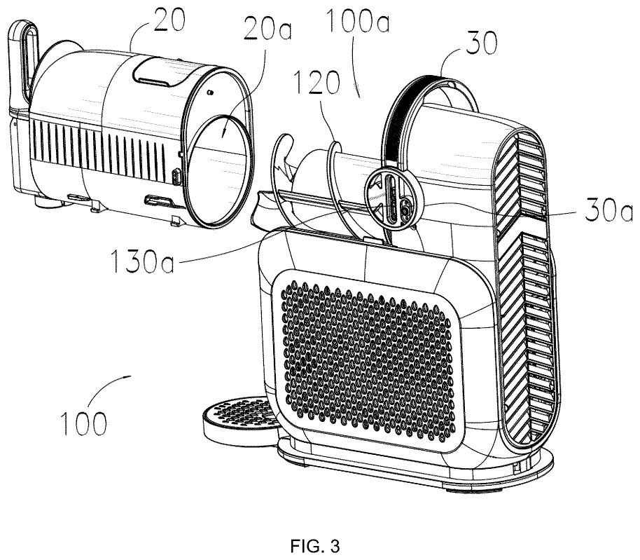

As shown in FIG. 1-FIG. 3, in a first embodiment of a frozen drink making machine in the present disclosure, the frozen drink making machine 100 includes a main body 10, a mixing container 20 and a lifting handle mechanism 30.

At least a compressor, a condenser, a rotating knife 120 and the lifting handle mechanism 30 mounted on left and right sides of an upper end of the main body 10 are configured inside the main body 10.

The mixing container 20 is configured at a front end of the frozen drink making machine 100, is a cylinder of a hollow structure 20a, and is configured to accommodate ice cubes, slush ice or a to-be-mixed finished product.

The rotating knife 120 is configured within the hollow structure 20a of the mixing container 20.

Two ends of the lifting handle mechanism 30 are configured on left and right sides of an upper end of the main body 10, and can be matched with clamping assemblies 20b of the mixing container 20, so as to control locking and separating states of the mixing container 20 with the main body 10.

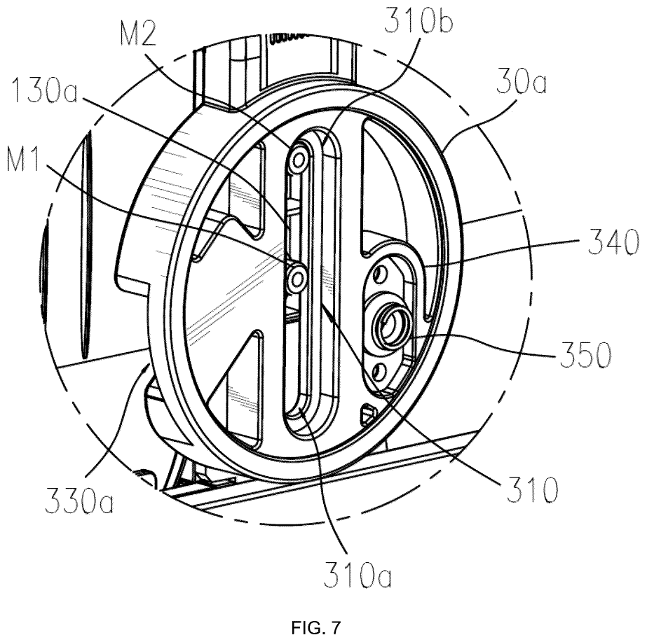

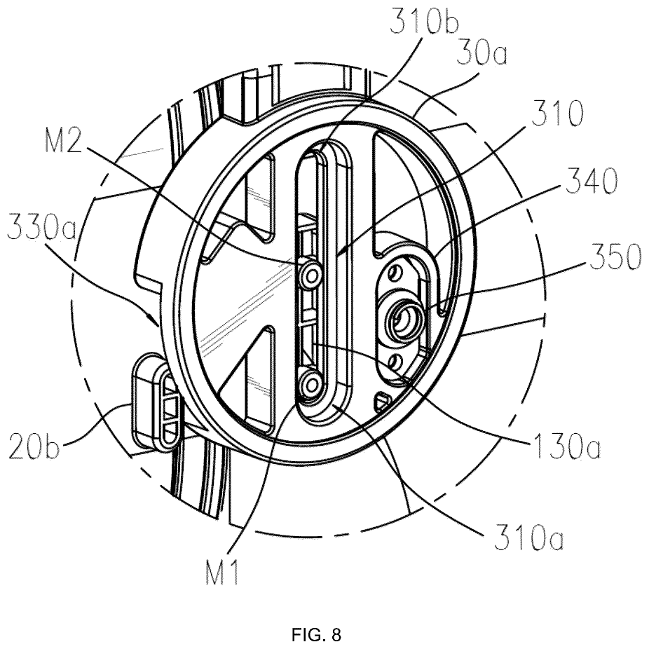

In a first embodiment of the lifting handle mechanism of the present disclosure as shown in FIG. 7 and FIG. 8, the lifting handle mechanism 30 is applied to the frozen drink making machine 100, and the lifting handle mechanism 30 can move radially along limiting assemblies 130a of the main body 10.

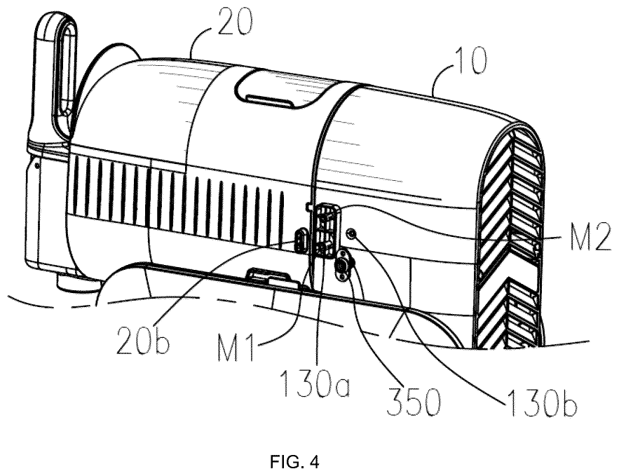

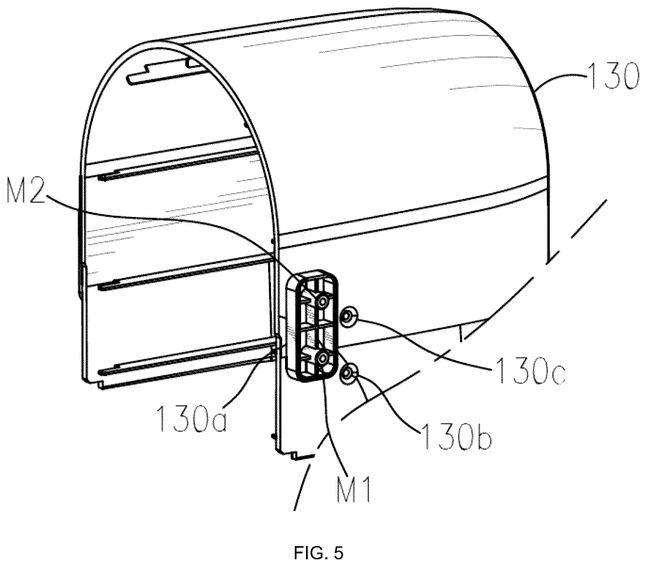

Specifically, as shown in FIG. 4 and FIG. 5, the limiting assemblies 130a are staggered or symmetrically arranged on the main body 10 and are set as square or circular bumps, and at least one limiting assembly 130a is provided.

At least one clamping assembly 20b is disposed on each of left and right sides of a rear end of the mixing container 20 and is set as a square or circular bump.

The at least one clamping assembly 20b is disposed on an adjacent side of the limiting assembly 130a.

For example, each clamping assembly 20b can be disposed on a left side, a right side, an upper side or a lower side of the limiting assembly 130a.

Opposite locking assemblies (30a, 30b) are disposed on the lifting handle mechanism 30 and are circular or square.

The locking assemblies (30a, 30b) can be respectively matched with the limiting assemblies 130a to detachably fix same to the main body 10.

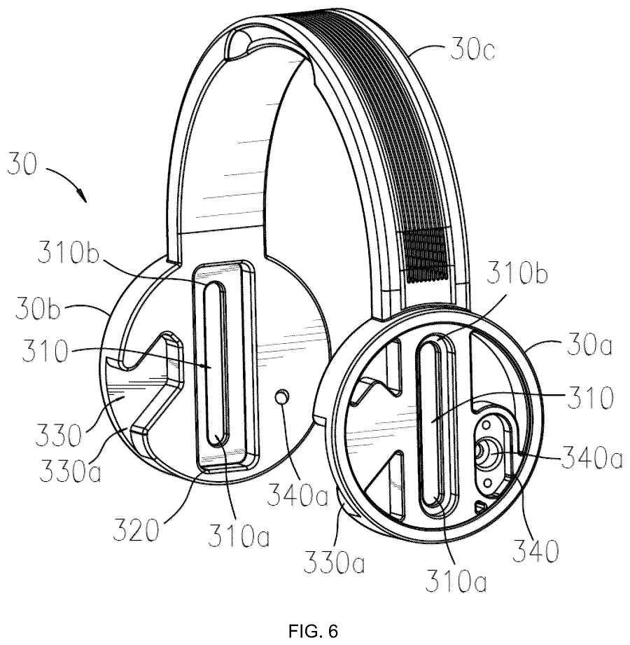

As shown in FIG. 6, through grooves 310 are formed in the locking assemblies (30a, 30b), and the through grooves 310 are matched with the limiting assemblies 130a, so that the locking assemblies (30a, 30b) can move up and down along the limiting assemblies 130a by means of the through grooves 310.

As shown in FIG. 8, when the locking assemblies (30a, 30b) are pulled upwards along the limiting assemblies 130a and first ends 310a of the locking assemblies (30a, 30b) move to first ends M1 of the limiting assemblies 130a, the clamping assemblies 20b are separated from the locking assemblies (30a, 30b), and a user can take out the mixing container 20 in a user interface direction of the main body 10, so as to separate the mixing container 20 from the main body 10.

As shown in FIG. 7, the hollow structure 20a of the mixing container 20 is embedded along a placement space 100a provided with the rotating knife 120, so that the hollow structure 20a of the mixing container 20 is opposite to a sealing assembly of the main body 10; then the locking assemblies (30a, 30b) are pressed downwards along the limiting assemblies 130a, when second ends 310b of the locking assemblies (30a, 30b) move to second ends M2 of the limiting assemblies 130a, the clamping assemblies 20b are embedded into the locking assemblies (30a, 30b), and the clamping assemblies 20b abut against the locking assemblies (30a, 30b), thereby locking the mixing container 20 on the main body 10.

With the adoption of the technical solution, the lifting handle mechanism 30 can be lifted or pressed; when the lifting handle mechanism 30 is lifted upwards, the first ends of the locking assemblies (30a, 30b) move to the first ends of the limiting assemblies 130a, and the clamping assemblies 20b can be pushed by means of sliding rails/through grooves to open the mixing container 20; when the lifting handle mechanism 30 is pressed downwards, the second ends of the locking assemblies (30a, 30b) move to the second ends of the limiting assemblies, and the clamping assemblies 20b can be clamped into the locking assemblies (30a, 30b) to lock the mixing container 20.

In some embodiments, as shown in FIG. 6, symmetric open grooves 330 are formed in inner sides of the locking assemblies (30a, 30b), and the open grooves 330 are of cuboid structures.

A notch 330a is formed in one end of each of the open grooves 330 along outer edges of the locking assemblies (30a, 30b).

The notches 330a are configured for placement or separation of the clamping assemblies 20b.

Specifically, as shown in FIG. 8, when the first ends 310a of the locking assemblies (30a, 30b) move to the first ends M1 of the limiting assemblies 130a, the clamping assemblies 20b are separated from the open grooves 330 of the locking assemblies (30a, 30b).

Specifically, when the locking assemblies (30a, 30b) are pulled upwards along the limiting assemblies 130a and the first ends 310a of the locking assemblies (30a, 30b) move to the first ends M1 of the limiting assemblies 130a, the clamping assemblies 20b can be separated from the locking assemblies (30a, 30b) by means of the notches 330a of the open grooves 330.

As shown in FIG. 7, when the second ends 310b of the locking assemblies (30a, 30b) move to the second ends M2 of the limiting assemblies 130a, the clamping assemblies 20b are embedded into the open grooves 330 of the locking assemblies (30a, 30b).

Specifically, the locking assemblies (30a, 30b) are pressed downwards along the limiting assemblies 130a, when the second ends 310b of the locking assemblies (30a, 30b) move to the second ends M2 of the limiting assemblies 130a, the clamping assemblies 20b can be embedded into the locking assemblies (30a, 30b) by means of the notches 330a of the open grooves 330.

In some embodiments, as shown in FIG. 6, in order to limit the maximum displacement of the upward/downward movement of the locking assemblies (30a, 30b) along the limiting assemblies 130a, the through grooves 310 can be formed in the locking assemblies (30a, 30b), placement grooves 320 are formed in inner sides of the through grooves 310, and the placement grooves 320 are of cuboid structures.

End surfaces of the limiting assemblies 130a are attached to end surfaces of the placement grooves 320, and extending portions of the limiting assemblies 130a are disposed inside the through grooves 310.

In some embodiments, as shown in FIG. 6, a placement cavity 340 is formed on one side of each through groove 310, and a through circular hole 340a is formed in the placement cavity 340.

In some embodiments, as shown in FIG. 7 and FIG. 8, an elastic assembly 350 is configured inside each placement cavity 340, and one end of the elastic assembly 350 passes through the through circular hole 340a.

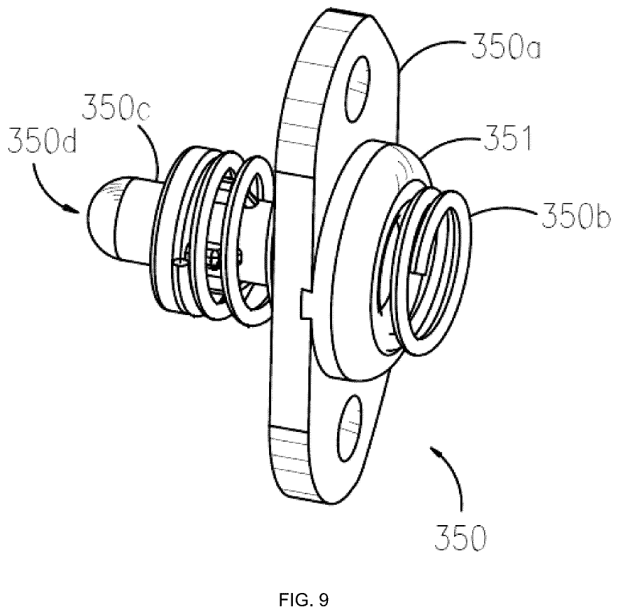

In some embodiments, as shown in FIG. 9, each elastic assembly 350 at least includes a support member 350a, a spring assembly 350b and a movable member 350c.

Each support member 350a is configured to fix the spring assembly 350b and the movable member 350c.

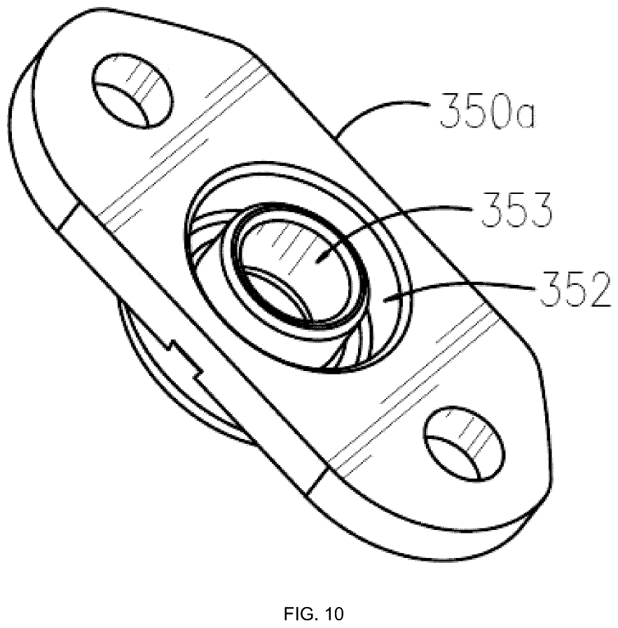

As shown in FIG. 10, a concave ring 352 is formed in an end surface of each support member 350a, and a convex ring 351 is formed on an opposite side of the concave ring 352.

A through hole 353 is formed in each concave ring 352.

One end of each spring assembly 350b is clamped inside the concave ring 352.

Each movable member 350c is sleeved with the spring assembly 350b, and the other end of the spring assembly 350b abuts against one end of the movable member 350c; and the axial moment of the movable member 350c is increased through arrangement of the spring assembly 350b.

One end of each movable member 350c is configured inside the through hole 353.

In some embodiments, as shown in FIG. 5, in order to improve the matching stability between the mixing container 20 and the main body 10, first concave holes 130b and second concave holes 130c can be formed in an outer side of a housing 130.

The first concave holes 130b and the second concave holes 130c are formed on adjacent sides of the limiting assemblies 130a and are opposite to the clamping assemblies 20b.

The first concave holes 130b and the second concave holes 130c are radially formed.

Further, as shown in FIG. 8, when the first ends 310a of the locking assemblies (30a, 30b) move to the first ends M1 of the limiting assemblies 130a, ends of the movable members 350c (belonging to the elastic assemblies 350) are embedded into the first concave holes 130b.

As shown in FIG. 8, when the second ends 310b of the locking assemblies (30a, 30b) move to the second ends M2 of the limiting assemblies 130a, the ends of the movable members 350c (belonging to the elastic assemblies 350) are separated from the first concave holes 130b, are embedded into the second concave holes 130c, and are matched with the clamping assemblies 20b, thereby improving the matching stability between the mixing container 20 and the main body 10.

In some embodiments, as shown in FIG. 6, a connecting assembly 30c is disposed between the locking assemblies (30a, 30b), and the connecting assembly 30c and the locking assemblies (30a, 30b) are integrally injection-molded.

The embodiments of the present disclosure are described above in conjunction with the accompanying drawings. However, the present disclosure is not limited to the above particular embodiments. The above particular embodiments are only exemplary and are not restrictive. With the motivation from the present disclosure, those of ordinary skill in the art can make many forms without departing from the purpose of the present disclosure and the scope of protection of the claims, and all these forms fall within the protection of the present disclosure.

1. A lifting handle mechanism applied to a frozen drink making machine, wherein
at least one limiting assembly is disposed on a main body, and at least one clamping assembly is disposed on a mixing container;
the at least one clamping assembly is disposed on an adjacent side of the limiting assembly;
the lifting handle mechanism is provided with a locking assembly matched with the limiting assembly;
when a first end of the locking assembly moves to a first end of the limiting assembly, the clamping assembly is separated from the locking assembly so as to control the mixing container to be separated from the main body; and
when a second end of the locking assembly moves to a second end of the limiting assembly, the clamping assembly is embedded into the locking assembly so as to lock the mixing container on the main body.

2. The lifting handle mechanism according to claim 1, wherein
a symmetric open groove is formed in an inner side of the locking assembly;
a notch is formed in one end of the open groove along an outer edge of the locking assembly; and
the notch is configured for placement or separation of the clamping assembly.

3. The lifting handle mechanism according to claim 2, wherein
when the first end of the locking assembly moves to the first end of the limiting assembly, the clamping assembly is separated from the locking assembly by means of the open groove; and
when the second end of the locking assembly moves to the second end of the limiting assembly, the clamping assembly is embedded into the locking assembly by means of the open groove.

4. The lifting handle mechanism according to claim 3, wherein
a through groove is formed in the locking assembly, and a placement groove is formed in an inner side of the through groove; and
an end surface of the limiting assembly is attached to an end surface of the placement groove, and an extending portion of the limiting assembly is disposed inside the through groove.

5. The lifting handle mechanism according to claim 4, wherein
a placement cavity is formed on one side of the through groove, and a through circular hole is formed in the placement cavity.

6. The lifting handle mechanism according to claim 5, wherein
an elastic assembly is configured inside the placement cavity, and one end of the elastic assembly passes through the through circular hole.

7. The lifting handle mechanism according to claim 6, wherein
the elastic assembly at least comprises a support member, a spring assembly and a movable member;
a concave ring is formed in an end surface of the support member, and a through hole is formed in the concave ring;
one end of the spring assembly is clamped inside the concave ring;
the movable member is sleeved with the spring assembly, and the other end of the spring assembly abuts against one end of the movable member; and
one end of the movable member is configured inside the through hole.

8. The lifting handle mechanism according to claim 7, wherein
a first concave hole and a second concave hole are formed on an opposite side of the clamping assembly; and
the first concave hole and the second concave hole are radially formed.

9. The lifting handle mechanism according to claim 8, wherein
when the first end of the locking assembly moves to the first end of the limiting assembly, the other end of the movable member is embedded into the first concave hole; and
when the second end of the locking assembly moves to the second end of the limiting assembly, the other end of the movable member is embedded into the second concave hole.

10. The lifting handle mechanism according to claim 9, wherein a connecting assembly is disposed between the locking assemblies.
